(19) United States
(12) Patent Application Publication
(10) Pub. No.: US 2011/0080540 A1
(43) Pub. Date: Apr. 7, 2011

(54) LIGHTING DEVICE AND LIQUID CRYSTAL DISPLAY DEVICE

(75) Inventor: Akira Tomiyoshi, Osaka (JP)

(73) Assignee: SHARP KABUSHIKI KAISHA, Osaka-shi, Osaka (JP)

(21) Appl. No.: 12/997,255

(22) PCT Filed: Apr. 16, 2009
(86) PCT No.: PCT/JP2009/057644

§ 371 Date: Dec. 10, 2010

(30) Foreign Application Priority Data
Jul. 8, 2008 (JP) 2008-178115

(51) Int. Cl. G02F 1/13357; G02F 1/1335

(52) U.S. Cl. 349/62; 362/97.1

(57) ABSTRACT

A lighting device which is thin and has improved heat dissipation properties. The device (10) is provided with light guide plates (1), light source substrates (2), a chassis (5) on which the light guide plates (1) and the light source substrates (2) are mounted, and driver substrates (6) located on the side of the rear surface of the chassis (5). One driver substrate (6) is provided for each two or more of the light source substrates (2).

### TECHNICAL FIELD

The present invention relates to a lighting device and a liquid crystal display device.

### BACKGROUND ART

Conventionally, a lighting device that uses a light-emitting diode (LED) and the like as a light source is known and used as a backlight unit that lights a liquid crystal display panel of a liquid crystal display device. In such a lighting device, a driver board is disposed on a rear surface (opposite to a liquid crystal display panel) of a chassis on which the light source and the like are mounted and the light source is connected to the driver board to drive the light source.

In the meantime, conventionally, as a lighting device that serves as a backlight unit, there is a lighting device of a tandem type. A lighting device of the tandem type is a lighting device in which a plurality of wedge-shape light guide plates are disposed consecutively; and in order for an LED to face a light input surface of the light guide plate, a plurality of light-source boards on each of which the LED is mounted are disposed. As for the light guide plate used in the lighting device of the tandem type, a predetermined side end surface serves as the light input surface; and a surface (surface that faces the liquid crystal display panel) perpendicular to the light input surface serves as a light output surface, and is formed in such a way that the thickness of the light guide plate becomes small as the light output surface goes from the light input surface to a side end surface opposite to the light input surface. In other words, the rear surface of the light guide plate opposite to the light output surface is inclined.

However, in the conventional lighting device of the tandem type, because the plurality of light-source boards are used, the number of driver boards for driving the light-source boards increases all the more. Accordingly, because the rear surface of the chassis is covered by the many driver boards, heat radiation performed via the chassis becomes insufficient, so that a disadvantage is likely to occur, in which the temperature of the LED rises and the brightness and life of the LED deteriorate.

To avoid this, conventionally, to radiate the heat generated by the LED, various methods are proposed (e.g., see a patent document 1). This patent document 1 discloses a technology in which a heat radiation plate is mounted on a light-source board and in this state, the light-source board is mounted on a chassis, so that the heat radiation characteristic is improved.

Prior-art Document

Patent Document

Patent document 1: JP-A-2005-353498

### SUMMARY OF THE INVENTION

### Problems to be Solved by the Invention

However, in the structure in the above patent document 1, the heat radiation plate is sandwiched between the light-source board and the chassis, which becomes an obstacle in achieving thickness reduction of the device. In other words, in the structure in the above patent document 1, it is hard to improve the heat radiation characteristic while achieving the thickness reduction of the device.

The present invention has been made to deal with the above problems, and it is an object of the present invention to provide a lighting device and a liquid crystal display device that are able to improve a heat radiation characteristic while achieving thickness reduction of the device.

### Means for Solving the Problem

To achieve the above object, a lighting device according to a first aspect of the present invention includes:

a plurality of light guide plates each of which has at least:

a light input surface that includes a predetermined side end surface;

a light output surface that includes a surface perpendicular to the light input surface; and

a rear surface that is a surface opposite to the light output surface;

wherein each of the plurality of light guide plates is formed into such a wedge shape that thickness of the light guide plate gradually becomes small as the rear surface goes away from the light input surface, and the plurality of light guide plates are arrayed in such a way that the light input surfaces face the same direction;

the light guide device further comprises:

a plurality of light-source boards each of which has:
a mount portion in which a light-emitting diode is mounted; and
a connection portion that connects to the mount portion;

wherein at least the connection portion has flexibility;

a chassis which has a mount surface on which the light guide plate and the light-source board are mounted and is provided with a draw-out opening for drawing out the connection portion of the light-source board from the mount surface to a rear surface opposite to the mount surface; and

a driver board which is disposed on the rear surface of the chassis and to which the connection portion of the light-source board is connected.

And, in a case where a direction parallel to the light input surface of the light guide plate is used as a line direction, in order for the light-emitting diode to face the light input surface of the light guide plate, a predetermined number of the light-source boards are disposed in each line; and the driver board is disposed at a ratio of one driver board to two or more light-source boards.

In the lighting device according to the first aspect, according to the above structure, it is possible to reduce the number of driver boards. Accordingly, even in the tandem type, because an area ratio of the driver board to the rear surface of the chassis becomes low, it is possible to enlarge the area of an exposed portion (portion that is not covered by the driver board) of the rear surface of the chassis. Because of this, without mounting a heat radiation member and the like on the light-source board, it is possible to efficiently perform radiation of the heat generated by the light-emitting diode. As a result of this, while achieving the thickness reduction of the device, it becomes possible to improve the heat radiation characteristic. Moreover, because the number of the driver boards is reduced, it is also possible to achieve weight and cost reductions of the device.

Besides, in the lighting device having the above structure according to the first aspect, in a case where the lighting device is used as a backlight unit for a large liquid crystal display device, while reducing the number of the driver boards, it is possible to dispose the light-emitting diode across the entire surface of the large screen. Accordingly, for example, by means of so-called local dimming backlight control that locally controls the brightness of light from a lighting device in accordance with an image signal, while achieving size reduction and improvement of the heat radiation characteristic of the device, it becomes possible to perform the control in such a way that the brightness distribution becomes appropriate across the entire surface of the large screen.

In the lighting device according to the above first aspect, it is desirable that the light-source board includes a flexible printed wiring board in which the mount portion and the connection portion are unitarily formed with each other.

In the lighting device according to the above first aspect, the connection portions of a plurality of the light-source boards for at least two lines may be connected to one driver board.

In this case, preferably, the light-source board included in one line and the light-source board included in the other line are formed into such a shape that when the light-source board included in the one line and the light-source board included in the other line are mounted on the mount surface of the chassis, positions in the line direction of the respective connection portions are away from each other. According to such a structure, when connecting the respective connection portions of the light-source board included in the one line and of the light-source board included in the other line to the driver board, the respective connection portions do not overlap with each other, so that it is possible to easily perform the connection of the light-source board to the driver board. Besides, also, confirmation after the connection of the light-source board to the driver board becomes easy.

Besides, in the above case, on the rear surface of the chassis, the driver board is disposed between the draw-out opening for the light-source board included in the one line and the draw-out opening for the light-source board included in the other line. According to such a structure, when connecting the respective connection portions of the light-source board included in the one line and of the light-source board included in the other line to the driver board, it is possible to connect the light-source board to the driver board without lapping the respective connection portions over each other. Accordingly, it is possible to easily perform the connection of the light-source board to the driver board and the confirmation after the connection of the light-source board to the driver board.

Besides, in the structure in which the connection portions of a plurality of the light-source boards for at least two lines are connected to one driver board, length of the connection portion of the light-source board included in the one line and length of the connection portion of the light-source board included in the other line may be different from each other. According to such a structure, it is possible to easily connect the respective connection portions of the light-source board included in the one line and of the light-source board included in the other line to the driver board.

In the lighting device according to the above first aspect, positions of the connection portions corresponding to the mount portions of the light-source boards which are disposed on both ends in the line direction may be different from each other.

In this case, preferably, the light-source board on one end and the light-source board on the other end are formed into such a shape that when the light-source board on the one end and the light-source board on the other end are mounted on the mount surface of the chassis, the respective connection portions come close to a central portion in the line direction. According to such a structure, it is possible to shorten the length in the line direction of the driver board. Accordingly, it is possible to enlarge the area of an exposed portion (portion that is not covered by the driver board) of the rear surface of the chassis and to further improve the heat radiation characteristic.

In the lighting device according to the above first aspect, preferably, a heat radiation member is disposed in a region of the rear surface of the chassis where the driver board is not disposed. According to such a structure, it becomes possible to achieve further improvement of the heat radiation characteristic

Besides, a liquid crystal display device according to a second aspect of the present invention includes: the lighting device according to the first aspect; and a liquid crystal display panel which is lit by the lighting device. According to such a structure, while achieving the thickness reduction of the device, it is possible to improve the heat radiation characteristic.

### ADVANTAGES OF THE INVENTION

As described above, according to the present invention, it is possible to easily obtain a lighting device and a liquid crystal display device that are able to improve a heat radiation characteristic while achieving thickness reduction of the device.

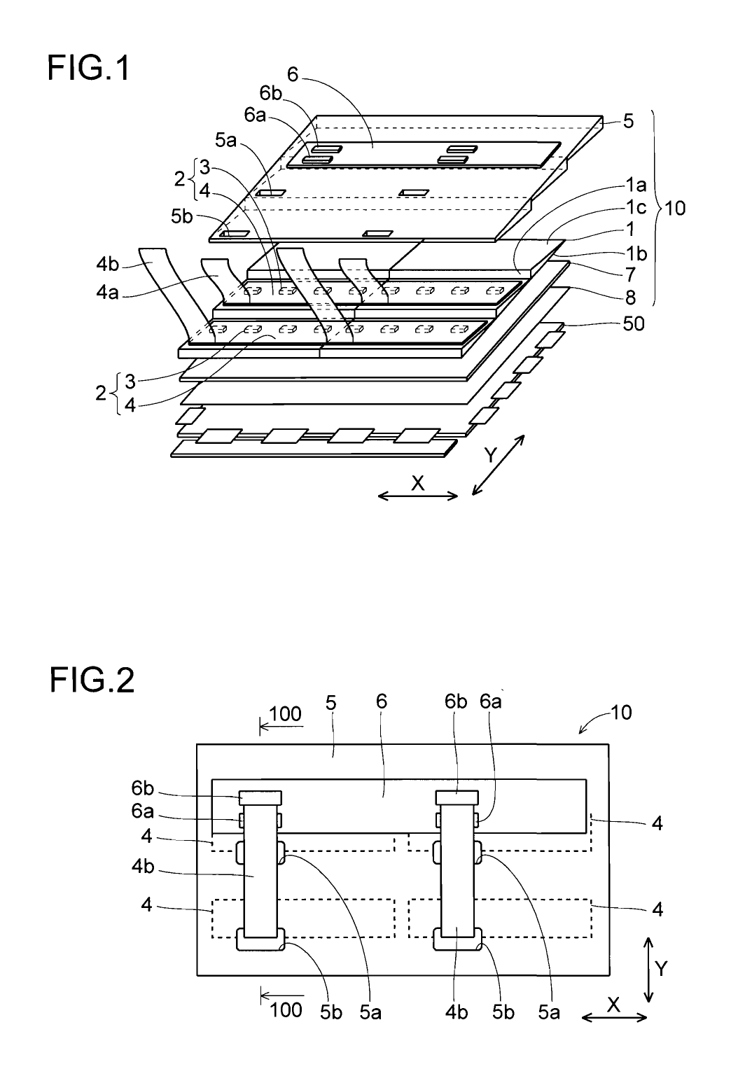

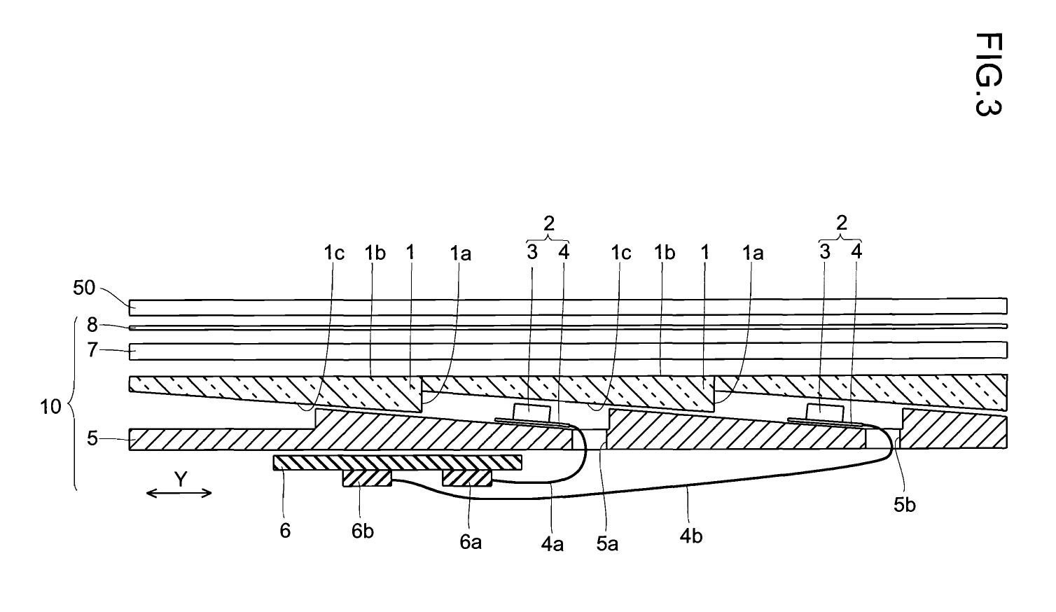

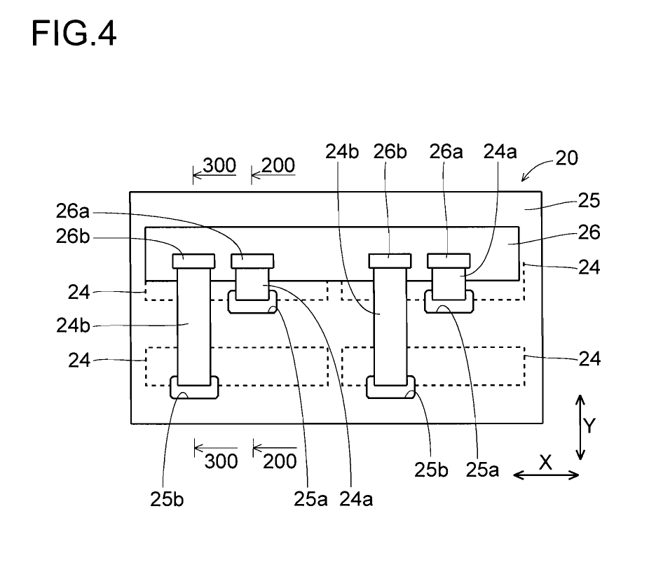

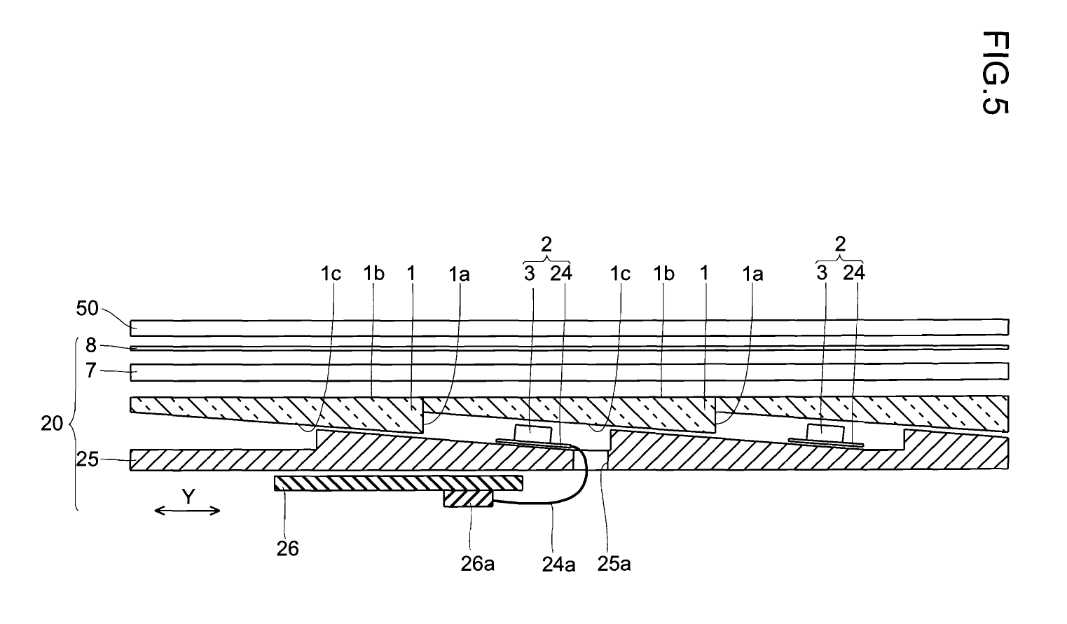

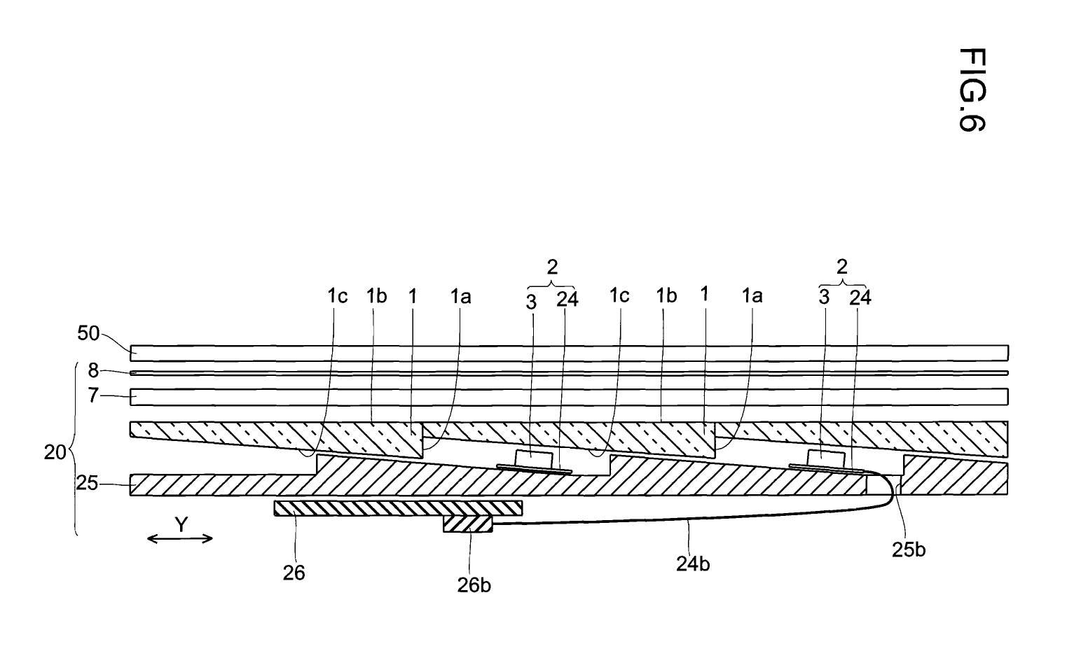

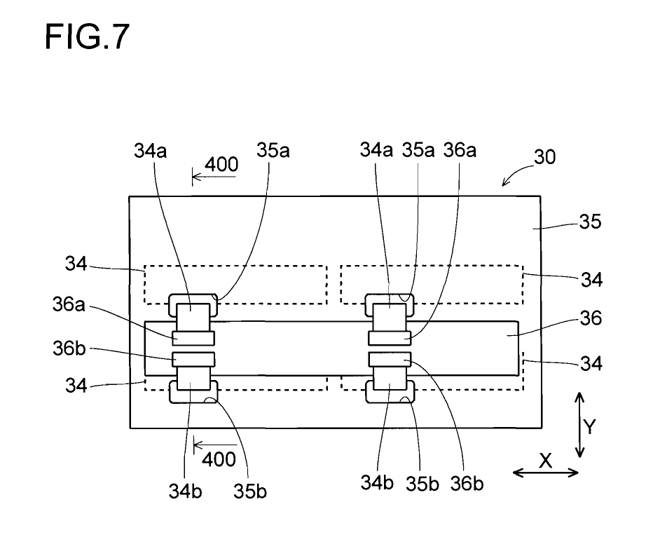

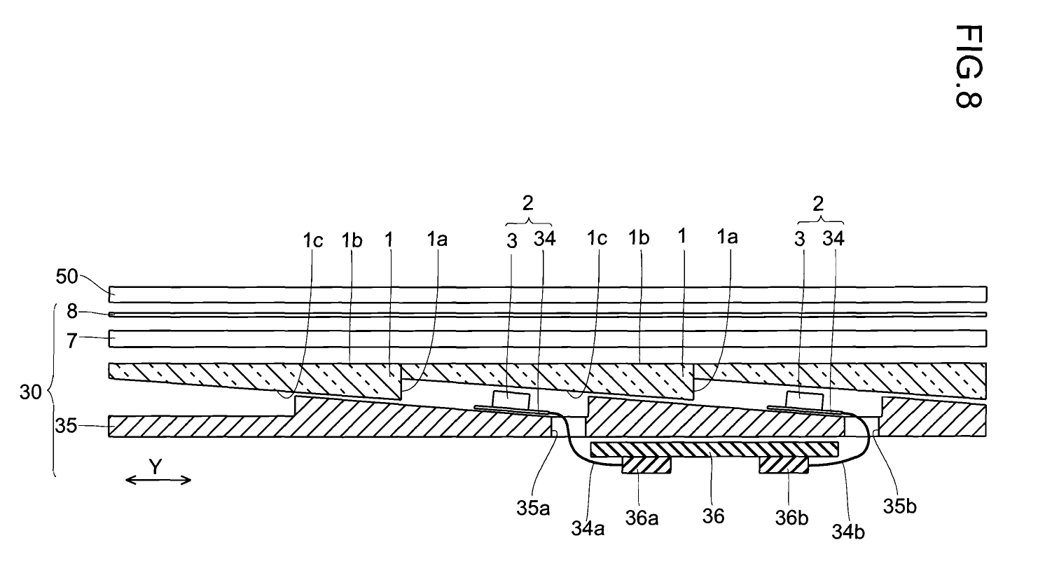

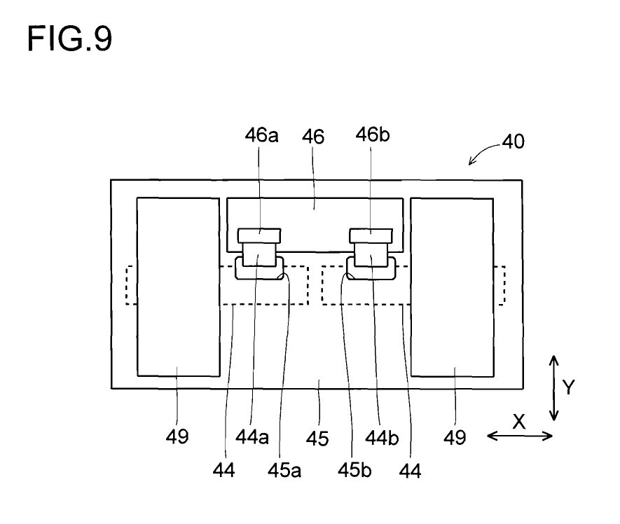

### BRIEF DESCRIPTION OF THE DRAWINGS

[FIG. 1] is an exploded perspective view of a lighting device according to a first embodiment of the present invention.

[FIG. 2] is a plan view when seeing the lighting device shown in FIG. 1 according to the first embodiment from a rear surface side.

[FIG. 3] is a sectional view along a 100-100 line in FIG. 2.

[FIG. 4] is a plan view when seeing a lighting device according to a second embodiment from a rear surface side.

[FIG. 5] is a sectional view along a 200-200 line in FIG. 4.

[FIG. 6] is a sectional view along a 300-300 line in FIG. 4.

[FIG. 7] is a plan view when seeing a lighting device according to a third embodiment from a rear surface side.

[FIG. 8] is a sectional view along a 400-400 line in FIG. 7.

[FIG. 9] is a plan view when seeing a lighting device according to a fourth embodiment from a rear surface side.

### BEST MODE FOR CARRYING OUT THE INVENTION

### FIRST EMBODIMENT

First, with reference to FIG. 1 to FIG. 3, a structure of a lighting device 10 according to a first embodiment is described.

The lighting device 10 according to the first embodiment, as shown in FIG. 1 to FIG. 3, is used as a backlight unit that lights a liquid crystal display panel 50 of a liquid crystal display device; and disposed on a rear surface opposite to a display surface of the liquid crystal display panel 50. Besides, the lighting device 10 is of a tandem type which includes: a plurality of light guide plates 1; a plurality of light-source boards 2 and the like.

The light guide plate 1 guides light from the light-source board 2, outputs the light to the liquid crystal display panel 50, and is formed of a transparent resin material and the like. Besides, the light guide plate 1 has at least: a light input surface 1a that includes a predetermined side end surface; a light output surface 1b that includes a surface (surface that faces the liquid crystal display panel 50) perpendicular to the light input surface 1a; and a rear surface 1c that is a surface opposite to the light output surface 1b; and the light guide plate 1 is formed into such an inclined wedge shape that the thickness becomes small as the rear surface goes away from the light input surface 1a.

And, the plurality of light guide plates 1 are arrayed into a line shape in an X direction and a Y direction with no gap in such a way that the respective light input surfaces 1a face the same direction; and two light input surfaces 1a neighboring in the X direction are flush with each other. Here, in the following description, a direction (X direction) parallel to the light input surface 1a of the light guide plate 1 is called a line direction.

The light-source board 2 generates the light that is guided by the light guide plate 1 and includes a flexible printed wiring board (FPC) 4 on which a plurality of light-emitting diodes (LED) 3 are mounted. In order for a light-emitting surface of the LED 3 to face the light input surface 1a of the light guide plate 1, two light-source boards 2 (one for one light guide plate 1) are disposed for each line. Here, in FIG. 1 to FIG. 3, for simplification of the figures, only the light-source boards 2 for two lines are shown.

The FPC 4 included in the one line has: a mount portion on which the LED 3 is mounted; and a connection portion 4a that is connected to a driver board 6 described later. The mount portion of the FPC 4 is formed into such a belt shape (rectangular shape) that the X direction matches a longitudinal direction. And, the plurality of LEDs 3 mounted on the mount portion of the FPC 4 are arrayed in a line shape along the longitudinal direction (X direction) of the mount portion. Besides, the connection portion 4a of the FPC 4 extends in a direction perpendicular to the longitudinal direction (X direction) of the mount portion and is formed unitarily with the mount portion.

The FPC 4 included in the other line is the same as the FPC 4 included in the one line and has: a mount portion on which the LED 3 is mounted; and a connection portion 4b that is connected to a driver board 6 described later. However, the length of the connection portion 4a of the FPC 4 included in the one line is smaller than the length of the connection portion 4b of the FPC 4 included in the other line. Here, the FPC 4 included in the one line and the FPC 4 included in the other line are formed in such a way that when the FPCs are mounted on a mount surface of the chassis 5 described later, positions in the line direction (X direction) of the respective connection portions 4a and 4b match each other.

The above light guide plate 1 and light-source board 2 are mounted on the mount surface of the chassis 5 to be held. The mount surface of the chassis 5 has an uneven shape that reflects an uneven shape that occurs because the light guide plate 1 has the wedge shape. Besides, a predetermined portion of the chassis 5 is provided with a draw-out opening 5a for the FPC 4 included in the one line and a draw-out opening 5b for the FPC 4 included in the other line. And, via the draw-out opening 5a of the chassis 5, the connection portion 4a of the FPC 4 included in the one line is drawn out to a rear surface (opposite to the mount surface of the chassis 5) of the chassis 5; and via the draw-out opening 5b of the chassis 5, the connection portion 4b of the FPC 4 included in the other line is drawn out to the rear surface of the chassis 5. Here, the draw-out openings 5a and 5b of the chassis 5 are disposed respectively in the corresponding lines in such a way that the positions in the line direction (X direction) match each other.

Besides, on the rear surface of the chassis 5, the driver board 6 for driving the LED 3 is disposed. And, the connection portion 4a of the FPC 4 included in the one line and the connection portion 4b of the FPC 4 included in the other line are connected to the driver board 6.

Here, in the first embodiment, the driver board 6 is disposed at a ratio of one driver board 6 to two or more light-source boards 2. Specifically, all of the FPCs 4 (the FPC 4 included in the one line and the FPC 4 included in the other line) for two lines are connected to one driver board 6. In other words, one driver board 6 is provided with: a connector 6a to which the connection portion 4a of the FPC 4 included in the one line is connected; and a connector 6b to which the connector portion 4b of the FPC 4 included in the other line is connected. Besides, the connectors 6a and 6b of the driver board 6 are disposed away from each other by a predetermined distance in the Y direction in such a way that the positions in the line direction (X direction) match each other. Because of this, when the connection portion 4a of the FPC 4 included in the one line and the connection portion 4b of the FPC 4 included in the other line are connected respectively to the connectors 6a and 6b of the driver board 6, the connection portion 4a of the FPC 4 included in the one line and the connection portion 4b of the FPC 4 included in the other line overlap with each other.

Besides, on the light output surface 1b of the light guide plate 1, a diffusion plate 7 and an optical sheet 8 are successively disposed. The diffusion plate 7 is formed of a resin or glass and disposed to diffuse the light output from the light output surface 1b of the light guide plate 1. By disposing such diffusion plate 7, it is possible to allow deterioration of the brightness of a region corresponding to an area between two neighboring light guide plates 1 to become unlikely to be visually recognized. Besides, the optical sheet 8 includes: a prism sheet that has a prism for collecting the light from the diffusion plate 7 in a front-surface direction (direction to the liquid crystal display panel 50); a diffusion sheet and the like that further diffuse the light from the diffusion plate 7 to reduce occurrence of brightness unevenness.

In the lighting device 10 according to the first embodiment, as described above, all of the FPCs 4 (the FPC 4 included in the one line and the FPC 4 included in the other line) for the two lines are connected to one driver board 6, so that it is possible to reduce the number of driver boards 6. Accordingly, even in the tandem type, the area ratio of the driver board 6 to the rear surface of the chassis 5 becomes low, so that it is possible to enlarge the area of the exposed portion (portion that is not covered by the driver board 6) of the rear surface of the chassis 5. Because of this, without mounting a heat radiation member and the like on the light-source board 2, it is possible to efficiently perform radiation the heat generated by the LED 3. As a result of this, while achieving the thickness reduction of the device, it is possible to improve the heat radiation characteristic. Moreover, because the number of driver boards 6 is reduced, it is also possible to achieve weight and cost reductions of the device.

Besides, in the lighting device 10 having the above structure according to the first embodiment, in a case were the lighting device 10 is used as a backlight unit of a large liquid crystal display device, while reducing the number of driver boards 6, it is possible to dispose the LED 3 across the entire surface of the large screen. Accordingly, for example, by means of so-called local dimming backlight control that locally controls the brightness of the light from the lighting device 10 in accordance with an image signal, while achieving size reduction and improvement of the heat radiation characteristic of the device, it is possible to perform the control in such a way that the brightness distribution becomes appropriate across the entire surface of the large screen.

### SECOND EMBODIMENT

Next, with reference to FIG. 4 to FIG. 6, a structure of a lighting device 20 according to a second embodiment is described.

In the second embodiment, as shown in FIG. 4 to FIG. 6, an FPC 24 included in one line and an FPC 24 included in the other line are formed in such a way that when the FPC 24 included in the one line and the FPC 24 included in the other line are mounted on a mount surface of a chassis 25, positions in the line direction (X direction) of the respective connection portions 24a and 24b are away from each other. Besides, in accordance with this, formation positions, with respect to the chassis 25, of a draw-out opening 25a for the FPC 24 included in the one line and of a draw-out opening 25b for the FPC 24 included in the other line are away from each other in the line direction (X direction).

And, in the second embodiment, all of the FPCs 24 (the FPC 24 included in the one line and the FPC 24 included in the other line) for two lines are connected to one driver board 26. A connector 26a for the FPC 24 included in the one line of the driver board 26 and a connector 26b for the FPC 24 included in the other line of the driver board 26 are away from each other in the line direction (X direction) in accordance with the distance in the line direction (X direction) between the connection portion 24a of the FPC 24 included in the one line and the connection portion 24b of the FPC 24 included in the other line.

Accordingly, when the connection portion 24a of the FPC 24 included in the one line and the connection portion 24b of the FPC 24 included in the other line are respectively connected to the connector 26a and the connector 26b of the driver board 26, a state shown in FIG. 4 to FIG. 6 is obtained.

The other structures in the second embodiment are the same as the above first embodiment.

In the second embodiment, according to the above structure, when the respective connection portions 24a and 24b of the FPC 24 included in the one line and of the FPC 24 included in the other line are connected to the driver board 26, the respective connection portions 24a and 24b do not overlap with each other, so that it is possible to easily perform the connection of the FPC 24 to the driver board 26. Besides, confirmation after the connection of the FPC 24 to the driver board 26 also becomes easy.

Here, the other advantages in the second embodiment are the same as the above first embodiment.

### THIRD EMBODIMENT

Next, with reference to FIG. 7 and FIG. 8, a structure of a lighting device 30 according to a third embodiment is described.

In the third embodiment, as shown in FIG. 7 and FIG. 8, an FPC 34 included in one line and an FPC 34 included in the other line are formed in such a way that when the FPC 34 included in the one line and the FPC 34 included in the other line are mounted on a mount surface of a chassis 35, positions in the line direction (X direction) of the respective connection portions 34a and 34b match each other. Here, a draw-out opening 35a for the FPC 34 included in the one line of the chassis 35 and of a draw-out opening 35b for the FPC 34 included in the other line of the chassis 35 are formed in such a way that their positions in the line direction (X direction) match each other.

Here, in the third embodiment, on a rear surface of the chassis 35, one driver board 36 is disposed between the draw-out opening 35a for the FPC 34 included in the one line and the draw-out opening 35b for the FPC 34 included in the other line; all of the FPCs 34 (the FPC 34 included in the one line and the FPC 34 included in the other line) for two lines are connected to one driver board 36. Here, a connector 36a for the FPC 34 included in the one line of the driver board 36 and a connector 36b for the FPC 34 included in the other line of the driver board 36 are formed in such a way that their positions in the line direction (X direction) match each other.

Accordingly, when the connection portion 34a of the FPC 34 included in the one line and the connection portion 34b of the FPC 34 included in the other line are respectively connected to the connector 36a of the driver board 36 and the connector 36b of the driver board 36, a state shown in FIG. 7 and FIG. 8 is obtained.

The other structures in the third embodiment are the same as the above first embodiment.

In the third embodiment, according to the above structure, when connecting the respective connection portions 34a and 34b of the FPC 34 included in the one line and of the FPC 34 included in the other line to the driver board 36, without lapping the respective connection portions 34a and 34b over each other, it is possible to connect the FPC 34 to the driver board 36. Accordingly, it is possible to easily perform the connection of the FPC 34 to the driver board 36 and confirmation after the connection of the FPC 34 to the driver board 36.

Besides, in the structure of the third embodiment having the above structure, because it is possible to shorten the length of the connection portion 34b of the FPC 34 included in the other line, it becomes possible to achieve further cost reduction.

Here, the other advantages in the third embodiment are the same as the above first embodiment.

### FOURTH EMBODIMENT

Next, with reference to FIG. 9, a lighting device 40 according to a fourth embodiment is described.

In the fourth embodiment, as shown in FIG. 9, formation positions of connection portions 44a and 44b corresponding to mount portions of FPCs 44 formed on both ends in the line direction (X direction) are different from each other. Specifically, the FPC 44 on one end side and the FPC 44 on the other end side are formed into such a shape that when the FPC 44 on the one end side and the FPC 44 on the other end side are mounted on a mount surface of a chassis 45, the respective connection portions 44a and 44b come close to a central portion in the line direction (X direction). Besides, in accordance with this, formation positions, with respect to the chassis 45, of a draw-out opening 45a for the FPC 44 included in the one line and of a draw-out opening 45b for the FPC 44 included in the other line are disposed close to the center in the line direction (X direction).

Here, in the fourth embodiment, a connector 46a for the FPC 44 on the one end side of the driver board 46 and a connector 46b for the FPC 44 on the other end side of the driver board 46 are disposed to come close to the central portion in the line direction (X direction). Because of this, the length in the line direction (X direction) of the driver board 46 is short compared with the other embodiments; and regions on both end sides in the line direction (X direction) of the rear surface of the chassis 45 are empty spaces. And, heat radiation members 49 such as a heat radiation fin, a heat pipe and the like are disposed in the empty spaces of the rear surface of the chassis 45.

The other structures in the fourth embodiment are the same as the above first embodiment.

In the fourth embodiment, according to the above structure, because it is possible to shorten the length in the line direction (X direction) of the driver board 46, the area of an exposed portion (portion that is not covered by the driver board 46) of the rear surface of the chassis 45 becomes larger, so that it becomes possible to dispose the heat radiation member 49 in the empty space of the rear surface of the chassis 45. Accordingly, it is possible to achieve further improvement of the heat radiation characteristic. Besides, because it is possible to shorten the length in the line direction (X direction) of the driver board 46, it becomes possible to achieve further cost reduction.

Here, the other advantages in the fourth embodiment are the same as the above first embodiment.

It should be considered that the embodiments disclose this time are examples in all respects and are not limiting. The scope of the present invention is not indicated by the above description of the embodiments but by the claims, and all modifications within the scope of the claims and the meaning equivalent to the claims are covered.

For example, in the first to fourth embodiments, the two light-source boards are disposed in each line; however, the present invention is not limited to this: three or more light-source boards may be disposed in each line.

Besides, in the first to fourth embodiments, the FPC, in which the mount portion (portion where the light-emitting diodes are mounted) and the connection portion (portion that is connected to the driver board) are unitarily formed, is used as the light-source board; however, the present invention is not limited to this: if the connection portion has flexibility, the mount portion and the connection portion may not be unitarily formed. In this case, the connection portion may be soldered to the mount portion, or may be press-attached to each other via an anisotropic electroconductive film (ACF). Besides, a connector may be disposed on the mount portion and the connection portion may be mounted on the connector.

Besides, in the first to third embodiments, the connection portions of the

FPCs for the two lines are connected to the one driver board; however, the present invention is not limited to this: the connection portions of the FPCs for three or more lines may be connected to the one driver board;

Besides, in the first to third embodiments, the lengths of the respective connection portions of the FPC included in the one line and the FPC included in the other line are different from each other; however, the present invention is not limited to this: the lengths of the respective connection portions of the FPC included in the one line and the FPC included in the other line may be the same as each other. In this case, the connection portion of the FPC included in the one line may be sufficiently folded.

Besides, in the fourth embodiment, the connection portion of the FPC for one line is connected to the one driver board; however, the present invention is not limited to this: the connection portions of the FPCs for two or more lines may be connected to the one driver board.

### LIST OF REFERENCE SYMBOLS

1 light guide plate

1a light input surface

1b light output surface

1c rear surface

2 light-source board

3 light-emitting diode

4, 24, 34, 44 flexible printed wiring boards

4a, 4b, 24a, 24b, 34a, 34b, 44a, 44b connection portions

5, 25, 35, 45 chassis

5a, 5b, 25a, 25b, 35a, 35b, 45a, 45b draw-out openings

6, 26, 36, 46 driver boards

10, 20, 30, 40 lighting devices

49 heat radiation member

50 liquid crystal display panel

1. A lighting device comprising:
a plurality of light guide plates each of which has at least:
a light input surface that includes a predetermined side end surface;
a light output surface that include a surface perpendicular to the light input surface; and
a rear surface that is a surface opposite to the light output surface;
wherein each of the plurality of light guide plates is formed into such a wedge shape that thickness of the light guide plate gradually becomes small as the rear surface goes away from the light input surface, and the plurality of light guide plates are arrayed in such a way that the light input surfaces face the same direction;
the light guide device further comprises:
a plurality of light-source boards each of which has:
a mount portion on which a light-emitting diode is mounted; and
a connection portion that connects to the mount portion;
wherein at least the connection portion has flexibility;
a chassis which has a mount surface on which the light guide plate and the light-source board are mounted and is provided with a draw-out opening for drawing out the connection portion of the light-source board from the mount surface to a rear surface opposite to the mount surface; and
a driver board which is disposed on the rear surface of the chassis and to which the connection portion of the light-source board is connected;
wherein in a case where a direction parallel to the light input surface of the light guide plate is used as a line direction, in order for the light-emitting diode to face the light input surface of the light guide plate, a predetermined number of the light-source boards are disposed in each line; and
the driver board is disposed at a ratio of one driver board to two or more light-source boards.

2. The lighting device according to claim 1, wherein the light-source board includes a flexible printed wiring board in which the mount portion and the connection portion are unitarily formed with each other.

3. The lighting device according to claim 1, wherein the connection portions of a plurality of the light-source boards for at least two lines are connected to one driver board.

4. The lighting device according to claim 3, wherein the light-source board included in one line and the light-source board included in the other line are formed into such a shape that when the light-source board included in the one line and the light-source board included in the other line are mounted on the mount surface of the chassis, positions of the respective connection portions in the line direction are away from each other.

5. The lighting device according to claim 3, wherein on the rear surface of the chassis, the driver board is disposed between the draw-out opening for the light-source board included in the one line and the draw-out opening for the light-source board included in the other line.

6. The lighting device according to claim 3, wherein length of the connection portion of the light-source board included in one line and length of the connection portion of the light-source board included in the other line are different from each other.

7. The lighting device according to claim 1, wherein positions of the connection portions corresponding to the mount portions of the light-source boards which are disposed on both ends in the line direction are different from each other.

8. The lighting device according to claim 7, wherein the light-source board on one end and the light-source board on the other end are formed into such a shape that when the light-source board on the one end and the light-source board on the other end are mounted on the mount surface of the chassis, the respective connection portions come close to a central portion in the line direction.

9. The lighting device according to claim 1, wherein a heat radiation member is disposed in a region of the rear surface of the chassis where the driver board is not disposed.

10. A liquid crystal display device comprising:
the lighting device according to claim 1; and
a liquid crystal display panel which is lit by the lighting device.

11. A liquid crystal display device comprising:
the lighting device according to claim 2; and
a liquid crystal display panel which is lit by the lighting device.

12. A liquid crystal display device comprising:
the lighting device according to claim 3; and
a liquid crystal display panel which is lit by the lighting device.

13. A liquid crystal display device comprising:
the lighting device according to claim 4; and
a liquid crystal display panel which is lit by the lighting device.

14. A liquid crystal display device comprising:
the lighting device according to claim 5 and
a liquid crystal display panel which is lit by the lighting device.

15. A liquid crystal display device comprising:
the lighting device according to claim 6; and
a liquid crystal display panel which is lit by the lighting device.

16. A liquid crystal display device comprising:
the lighting device according to claim 7; and
a liquid crystal display panel which is lit by the lighting device.

17. A liquid crystal display device comprising:
the lighting device according to claim 8; and
a liquid crystal display panel which is lit by the lighting device.

18. A liquid crystal display device comprising:
the lighting device according to claim 9; and
a liquid crystal display panel which is lit by the lighting device.
